(19) United States
(12) Patent Application Publication
(10) Pub. No.: US 2004/0060006 A1
(43) Pub. Date: Mar. 25, 2004

(54) XML-DB transactional update scheme

(75) Inventors: Christopher Lindblad, Berkeley, CA (US); Paul Pedersen, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cerisent Corporation, San Mateo, CA

(21) Appl. No.: 10/462,023

(22) Filed: Jun. 13, 2003

Related U.S. Application Data
(60) Provisional application No. 60/389,052, filed on Jun. 13, 2002.

(51) Int. Cl. G06F 15/00

(52) U.S. Cl. 715/513; 715/530

(57) ABSTRACT

In an XML handling system, point updates to an element of an XML document stored in the database is possible. Updates include addition or deletion of whole documents, addition of a child node to any element node (this includes attribute nodes), the addition of new siblings to any element node, the deletion of any element node, and the replacement of any node by a new node. The database system might include a set of functions that can be invoked to affect an update (i.e., an addition, deletion or modification). Such updates can be submitted as queries, such as instructions within an XQuery query.

### CROSS-REFERENCE TO RELATED APPLICATIONS

This application claims the benefit of U.S. Provisional Application No. 60/389,052, filed Jun. 13, 2002, entitled “XML DB TRANSACTIONAL UPDATE SYSTEM,” which disclosure is incorporated herein by reference for all purposes. The present disclosure is related to the following commonly assigned co pending U.S. patent applications:

No. ______ (Attorney Docket No. 021512 000110US, filed on the same date as the present application, entitled “A SUBTREE STRUCTURED XML DATABASE” (hereinafter “Lindblad I-A”);

No. ______ (Attorney Docket No. 021512 000210US, filed on the same date as the present application, entitled “PARENT-CHILD QUERY INDEXING FOR XML DATABASES” (hereinafter “Lindblad II-A”); and

No. ______ (Attorney Docket No. 021512 000410US, filed on the same date as the present application, entitled “XML DATABASE MIXED STRUCTURAL-TEXTUAL CLASSIFICATION SYSTEM” (hereinafter “Lindblad IV-A”); The respective disclosures of these applications are incorporated herein by reference for all purposes.

### BACKGROUND OF THE INVENTION

1. Field of the Invention

This invention relates in general to updating structured databases such as XML databases on a network, and more specifically, to updating one or more subtree-structured XML databases over a network.

2. Description of Related Art

Extensible Markup Language (XML) is a restricted form of SGML, the Standard Generalized Markup Language defined in ISO 8879 and XML is one form of structuring data. XML is more fully described in “Extensible Markup Language (XML) 1.0 (Second Edition)”, W3C Recommendation (Oct. 6, 2000), which is incorporated by reference herein for all purposes [and available at http://www.w3.org/TR/2000/REC-xml-20001006] (hereinafter, “XML Recommendation”). XML is a useful form of structuring data because it is an open format that is human-readable and machine-interpretable. Other structured languages without these features or with similar features might be used instead of XML, but XML is currently a popular structured language used to encapsulate (obtain, store, process, etc.) data in a structured manner.

An XML document has two parts: 1) a markup document and 2) a document schema. The markup document and the schema are made up of storage units called “elements”, which can be nested to form a hierarchical structure. An example of an XML markup document 10 is shown in FIG. 1. Document 10 (at least the portions shown) contains data for one “citation” element. The “citation” element has within it a “title” element, and “author” element and an “abstract” element. In turn, the “author” element has within it a “last” element (last name of the author) and a “first” element (first name of the author). Thus, an XML document comprises text organized in freely-structured outline form with tags indicating the beginning and end of each outline element.

Generally, an XML document comprises text organized in freely-structured outline form with tags indicating the beginning and end of each outline element. In XML, a tag is delimited with angle brackets followed by the tag's name, with the opening and closing tags distinguished by having the closing tag beginning with a forward slash after the initial angle bracket.

Elements can contain either parsed or unparsed data. Only parsed data is shown for document 10. Unparsed data is made up of arbitrary character sequences. Parsed data is made up of characters, some of which form character data and some of which form markup. The markup encodes a description of the document's storage layout and logical structure. XML elements can have associated attributes, in the form of name-value pairs, such as the publication date attribute of the “citation” element. The name-value pairs appear within the angle brackets of an XML tag, following the tag name.

XML schemas specify constraints on the structures and types of elements and attribute values in an XML document. The basic schema for XML is the XML Schema, which is described in “XML Schema Part 1: Structures”, W3C Working Draft (Sep. 24, 1999), which is incorporated by reference herein for all purposes [and available at http://www.w3.org/TR/1999/WD-xmlschema-1-19990924]. A previous and very widely used schema format is the DTD (Document Type Definition), which is described in the XML Recommendation.

Since XML documents are typically in text format, they can be searched using conventional text search tools. However such tools might ignore the information content provided by the structure of the document, one of the key benefits of XML. Several query languages have been proposed for searching and reformatting XML documents that do consider the XML documents as structured documents. One such language is XQuery, which is described in “XQuery 1.0: An XML Query Language”, W3C Working Draft (Dec. 20, 2001), which is incorporated by reference herein for all purposes [and available at http://www.w3.org/TR/XQuery]. An example of a general form for an XQuery query is shown in FIG. 2. Note that the ellipses at line [03] indicate the possible presence of any number of additional namespace prefix to URI mappings, the ellipses at line [12] indicate the possible presence of any number of additional function definitions and the ellipses at line [17] indicate the possible presence of any number of additional FOR or LET clauses.

XQuery is derived from an XML query language called Quilt [described at http://www.almaden.ibm.com/cs/people/chamberlin/quilt.html], which in turn borrowed features from several other languages, including XPath 1.0 [described at http://www.w3.org/TR/XPath.html], XQL [described at Http://www.w3.org/TandS/QL/QL98/pp/xql.html], XML-QL [described at http://www.research.att.com/˜mff/files/final.html] and OQL.

Query languages predated the development of XML and many relational databases use a standardized query language called SQL, as described in ISO/IEC 9075-1:1999. The SQL language has established itself as the linqua franca for relational database management and provides the basis for systems interoperability, application portability, client/server operation, and distributed databases. XQuery is proposed to fulfill a similar same role with respect to XML database systems. As XML becomes the standard for information exchange between peer data stores, and between client visualization tools and data servers, XQuery may become the standard method for storing and retrieving data from XML databases.

With SQL query systems, much work has been done on the issue of efficiency, such as how to process a query, retrieve matching data and present that to the human or computer query issuer with efficient use of computing resources to allow responses to be quickly made to queries. As XQuery and other tools are relied on more and more for querying XML documents, efficiency will be more essential.

### BRIEF SUMMARY OF THE INVENTION

An update system as described herein applies updates to XML nodes in an XML database. In an XML handling system according to one embodiment of the present invention, point updates to an element of an XML document stored in the XML database are possible. Updates might add or delete whole documents, add child nodes to a parent node where the child node is another XML element or an attribute of an existing XML element, adding new siblings to a node, deleting a node, replacement of a node by a new node, etc.

In a particular implementation, a database system includes a set of functions that can be invoked to affect an update (i.e., an addition, deletion or modification). Such updates can be submitted as queries, such as instructions within an XQuery query.

### BRIEF DESCRIPTION OF THE DRAWINGS

FIG. 1 is an illustration of XML markup.

FIG. 2 is an illustration of an XQuery query.

FIG. 3 is an illustration of a simple XML document including text and markup.

FIG. 4 is a schematic representation of the XML document shown in FIG. 3; FIG. 4A illustrates a complete representation the XML document and FIG. 4B illustrates a subtree of the XML document.

FIG. 5 is a schematic representation of a more concise XML document.

FIG. 6 illustrates a portion of an XML document that includes tags with attributes; FIG. 6A shows the portion in XML format; FIG. 6B is a schematic representation of that portion in graphical form.

FIG. 7 shows a more complex example of an XML document, having attributes and varying levels.

FIG. 8 is a schematic representation of the XML document shown in FIG. 7, omitting data nodes.

FIG. 9 illustrates one decomposition of the XML document illustrated in FIGS. 7-8.

FIG. 10 illustrates the decomposition of FIG. 9 with the addition of link nodes.

FIG. 11 is a block diagram of an XML handling system according to aspects of the present invention.

FIG. 12 is a flowchart of a process for performing an update to an XML database.

FIG. 13 illustrates a situation where an update encounters a link node.

FIG. 14 illustrates a method for updating subtree node counts and subtree ID slack.

FIG. 15 illustrates a subtree that represents a new document fragment.

FIG. 16 illustrates a subtree corresponding to the new document fragment of FIG. 15.

FIG. 17 illustrates new subtrees corresponding to the new document fragment of FIG. 15 and pre-existing nodes.

FIG. 18 represents a document fragment; FIG. 18A shows it in tree form; FIG. 18B shows it in XML form.

FIG. 19 illustrates a process for assigning ordinal values to nodes before and during an update step.

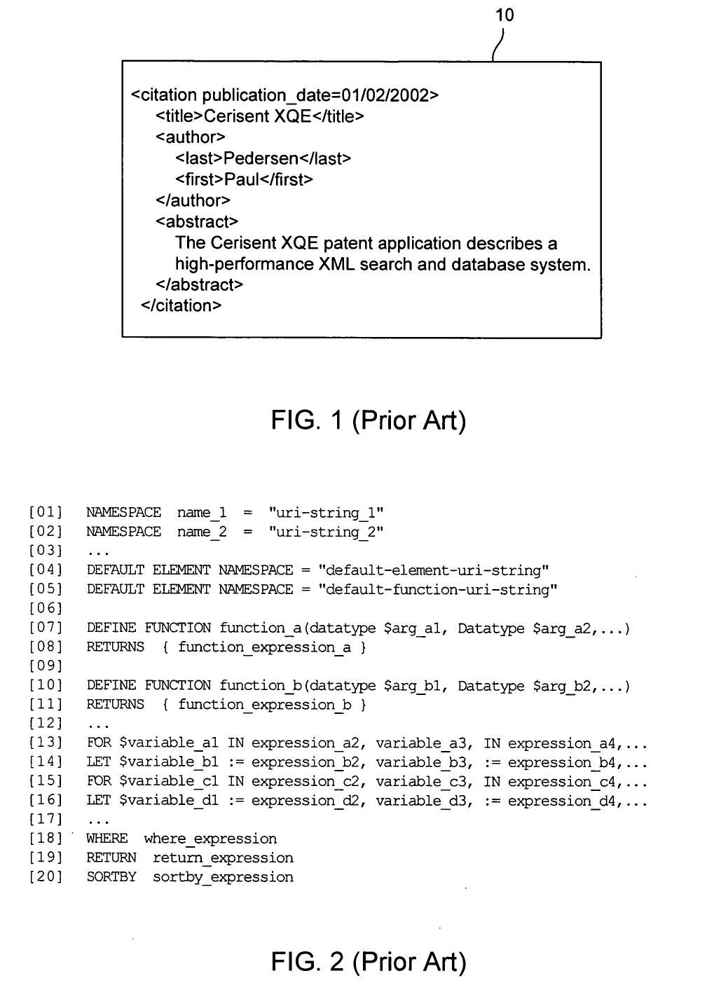

### DETAILED DESCRIPTION OF THE INVENTION

This detailed description illustrates some embodiments of the invention and variations thereof, but should not be taken as a limitation on the scope of the invention. In this description, structured documents are described, along with their processing, storage and use, with XML being the primary example. However, it should be understood that the invention might find applicability in systems other than XML systems, whether they are later-developed evolutions of XML or entirely different approaches to structuring data.

Overview

Systems for generating and managing XML databases are described in Lindblad I-A. The nodes may be of any type, such as element nodes, attribute nodes, text nodes, processing instruction nodes or comment nodes. The notation u(n) is used herein to indicate an update operation u applied to the node n. “Elements” are generally understood in the context of XML documents, but would also apply where the data being manipulated is other than XML documents. As used herein, an XML element comprises a tag name, zero or more attribute (name, value) pairs, and element content. Element content is typically zero or more characters of text and zero or more child elements, but element content might take other forms.

An update system as described herein applies updates to XML nodes in an XML database. In an XML handling system according to one embodiment of the present invention, point updates to an element of an XML document stored in the XML database are possible. Updates might add or delete whole documents, add child nodes to a parent node where the child node is another XML element or an attribute of an existing XML element, adding new siblings to a node, deleting a node, replacement of a node by a new node, etc.

Lindblad I-A describes how a collection of XML documents might be decomposed into a “forest” of “subtrees”, where each subtree describes a fragment within one of the XML documents.

Subtrees, Storage and Decomposition

Subtree storage is described in this section. Subtrcc storage is explained with reference to a simple example, but it should be understood that such techniques are equally applicable to more complex examples.

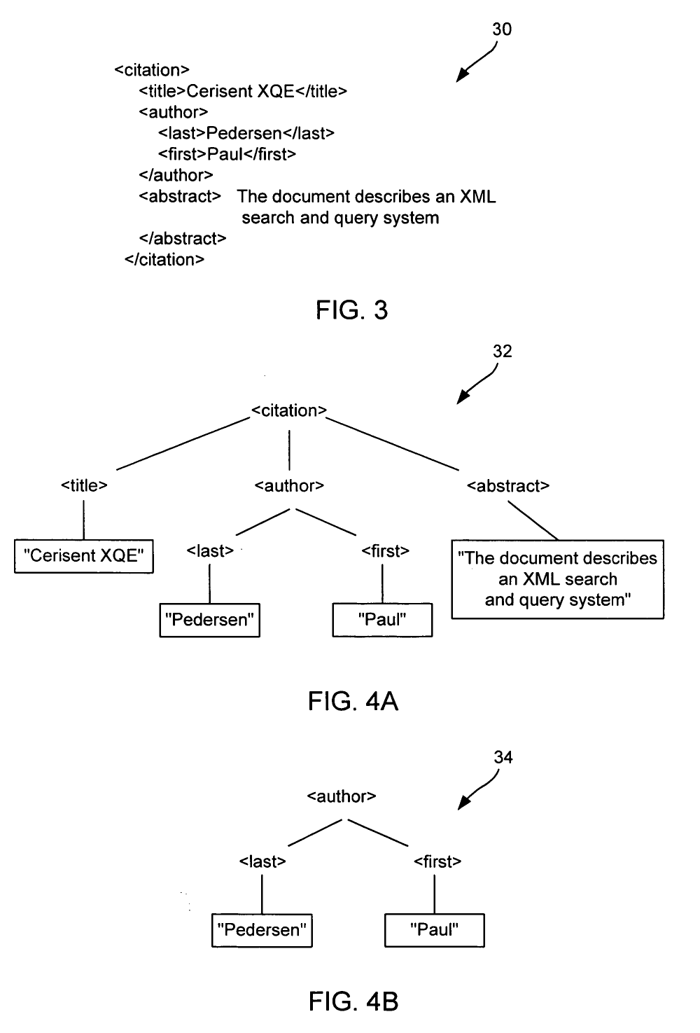

FIG. 3 illustrates an XML document 30, including text and markup. FIG. 4A illustrates a schematic representation 32 of XML document 30, wherein schematic representation 12 is a shown as a tree (a connected acyclic simple directed graph) with each node of the tree representing an element of the XML document or an element's content, attribute, the value, etc.

In a convention used for the figures of the present application, directed edges are oriented from an initial node that is higher on the page than the edge's terminal node, unless otherwise indicated. Nodes are represented by their labels, often with their delimiters. Thus, the root node in FIG. 4A is a “citation” node represented by the label delimited with “ [symbol] ”. Data nodes are represented by rectangles. In many cases, the data node will be a text string, but other data node types are possible. In many XML files, it is possible to have a tag with no data (e.g., where a sequence such as “<tag></tag>” exists in the XML file). In such cases, the XML file can be represented as shown in FIG. 4A but with some nodes representing tags being leaf nodes in the tree. The present invention is not limited by such variations, so to focus explanations, the examples here assume that each “tag” node is a parent node to a data node (illustrated by a rectangle) and a tag that does not surround any data is illustrated as a tag node with an out edge leading to an empty rectangle. Alternatively, the trees could just have leaf nodes that are tag nodes, for tags that do not have any data.

As used herein, “subtree” refers to a set of nodes with a property that one of the nodes is a root node and all of the other nodes of the set can be reached by following edges in the orientation direction from the root node through zero or more non-root nodes to reach that other node. A subtree might contain one or more overlapping nodes that are also members of other “inner” or “lower” subtrees; nodes beyond a subtree's overlapping nodes are not generally considered to be part of that subtree. The tree of FIG. 4A could be a subtree, but the subtree of FIG. 4B is more illustrative in that it is a proper subset of the tree illustrated in FIG. 4A.

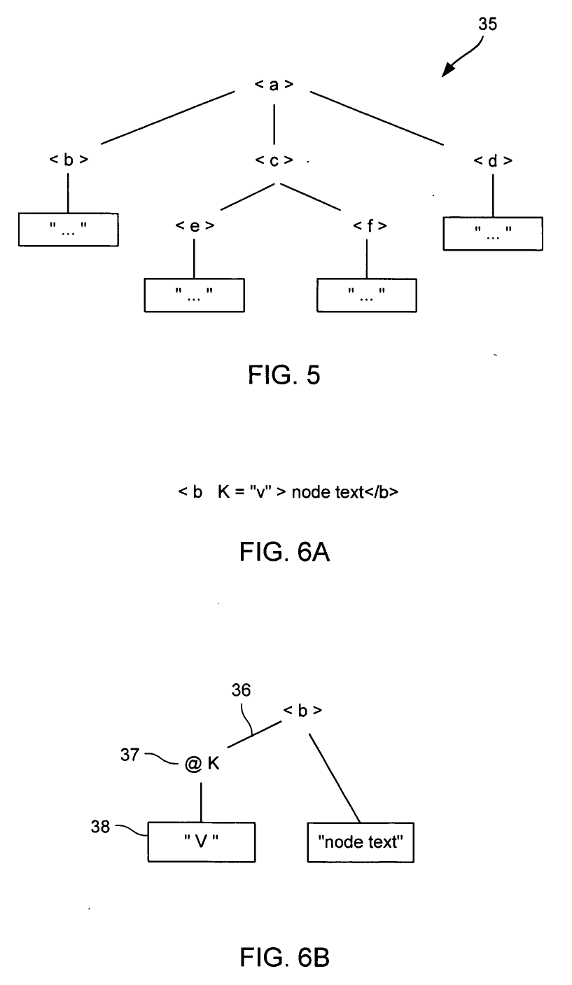

To simplify the following description and figures, single letter labels will be used, as in FIG. 5. Note that even with the shorted tags, tree 35 in FIG. 5 represents a document that has essentially the same structure as the document represented by the tree of FIG. 4A.

Some nodes may contain one or more attributes, which can be expressed as (name, value) pairs associated with nodes. In graph theory terms, the directed edges come in two flavors, one for a parent-child relationship between two tags or between a tag and its data node, and one for linking a tag with an attribute node representing an attribute of that tag. The latter is referred to herein as an “attribute edge”. Thus, adding an attribute (key, value) pair to an XML file would map to adding an attribute edge and an attribute node, followed by an attribute value node to a tree representing that XML file. A tag node can have more than one attribute edge (or zero attribute edges). Attribute nodes have exactly one descendant node, a value node, which is a leaf node and a data node, the value of which is the value from the attribute pair.

In the tree diagrams used herein, attribute edges sometimes are distinguished from other edges in that the attribute name is indicated with a preceding “@”. FIG. 6A illustrates a portion of XML markup wherein a tag T has an attribute name of “K” and a value of “V”. FIG. 6B illustrates a portion of a tree that is used to represent the XML markup shown in FIG. 6A, including an attribute edge 36, an attribute node 37 and a value node 38. In some instances, tag nodes and attribute nodes are treated the same, such as indexing sequences and the like, but other times are treated differently. To easily distinguish tag nodes and attribute nodes in the illustrated trees, tag nodes are delimited with surrounding angle brackets (“ [symbol] ”), while attribute nodes are be limited with an initial “@”.

Updating

Using such a structure for storing XML documents allows for dynamically updating an XML database of XML subtrees. Updates might include XML node deletion, replacement, and insertion. Nodes can be inserted as preceding siblings, following siblings, or as a new children nodes. Document nodes may be inserted or deleted. Nodes may be element nodes, attribute nodes, text nodes, processing instruction nodes or comment nodes.

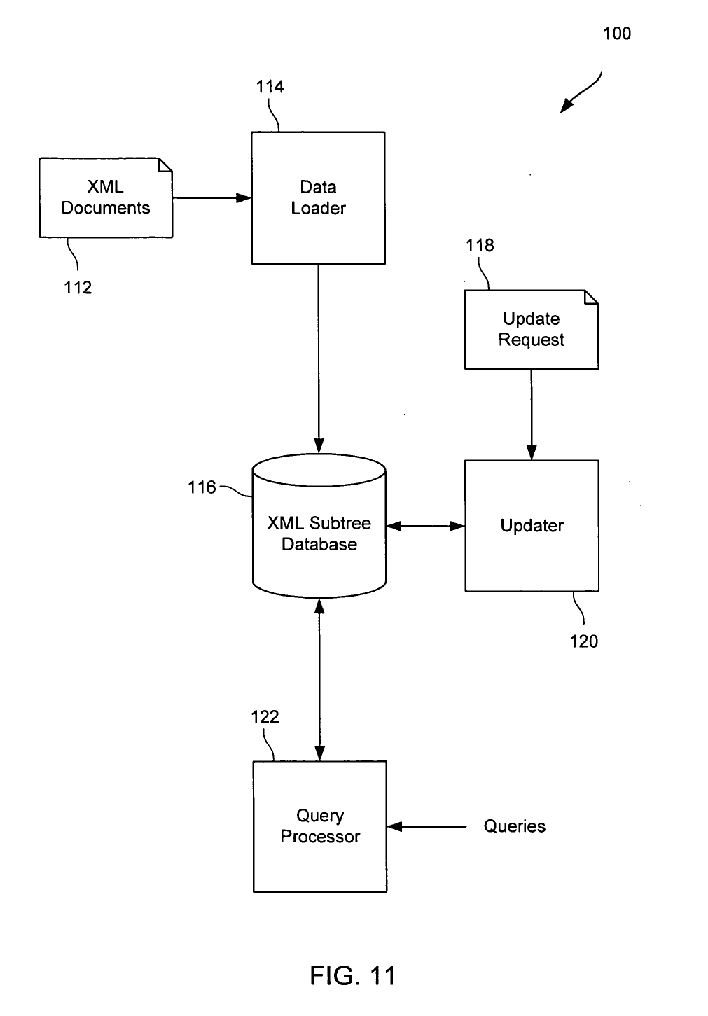

FIG. 11 is a block diagram of an XML handling system 100 that is amenable to updating XML databases. As illustrated there, XML handling system 100 might accept XML documents 112 using a data loader 114 data populates an XML subtree database 116 with subtrees representing portions of the accepted XML documents. XML handling system 100 might also accept update requests 118 via an updater 120. XML handling system 100 might also accept queries via a query processor 122.

In a particular implementation, a database system includes a set of functions that can be invoked to affect an update (i.e., an addition, deletion or modification). Such updates can be submitted as queries, such as instructions within an XQuery query, in which case query processor 122 would absorb the role of updater 120.

One basic update-related operation of XML handling system 100 is to locate the subtree S(n) containing the node n that is the target of an update and then to create an updated copy S′(n) of S(n). Once fully created, with all unaffected nodes copied, deleted nodes removed, and new nodes added, the obsolete subtree S(n) is atomically (transactionally) replaced in the database with the new, updated copy S′(n). The process of replacing S(n) with S′(n) may require a cascading sequence of additional updates as described below.

XML handling system 100 might use a two-step process for updates. First, updates are specified using a set of update value constructors. Secondly, the update values are committed to the database by a commit function. Each of these is described in more detail below.

The commit function accepts as input any sequence of values, including some number of update values; it performs the updates as a side-effect, and returns the non-update values as a result sequence. Any XQuery expression that includes some calls to the update value constructors and returns a sequence of values including some number of update values will be automatically passed to the commit function.

The update values appearing in the input to commit are processed concurrently and transactionally, which means that no assumptions may or need to be made about the order in which the updates are performed, and that either all the updates complete consistently, or none of them completes and the database remains in the state it was in prior to the call to commit. XML handling system 100 detects deadlock conditions that may occur as a consequence of committing competing sets of update values.

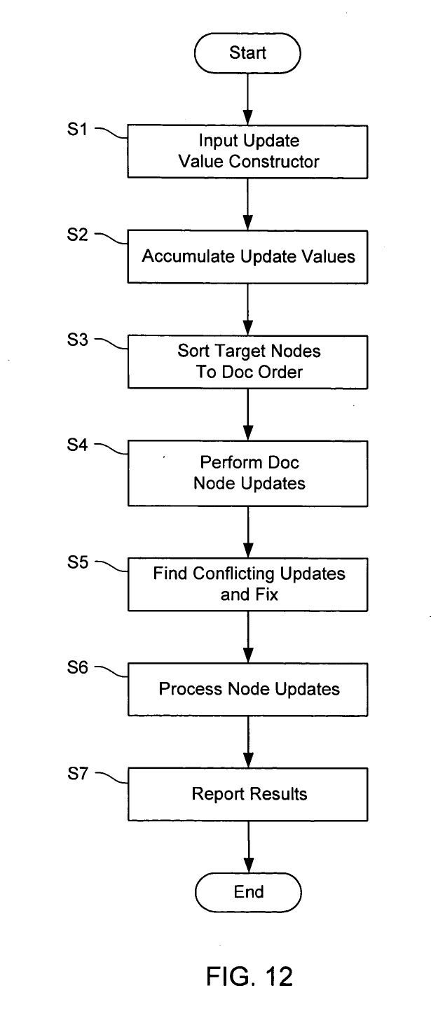

One such process for performing an update is illustrated in FIG. 12. As shown there, the system inputs an update value constructor (S1) and accumulates update values (S2). Accumulating input values involves scanning a commit input sequence and extracting update values therefrom. Next, the target nodes are sorted into document order (S3), resulting in a change vector containing the update values sorted by document order for the target nodes of the updates. DocNode updates (i.e., complete XML document updates) are disposed (S4) of because they do not involve interacting with a subtree structure—that just involves replacing a document.

Inconsistencies in the sets of update values appearing in the change vector are then detected and corrected (S5). Examples include node-replace requests that would update a descendant of replaced node and node-insert-child requests that conflict with a delete or replace of any ancestor of the node that is the target of the node-insert-child request.

Next, the node updates are processed (S6) and results reported (S7). The node update process loops over the ordered, non-conflicting node updates and creates all new updated subtrees. This step might use one or more of the subroutines shown in Appendix A.

Update Methods

The following section describes some methods that a database update module might employ in connection with updates. While the methods here are described with reference to XML documents, which are generally text files, the database system might accommodate other forms of structured data. The update system described here can be used with the XML subtree database system described in Lindblad I-A. The overall class object for a database system is referenced here as “xqe”.

The update methods involve a two-stage mechanism. The first stage specifies some form of update, and the second step commits the update to the database. The update specifications are described as “update values”. The “commit” function takes any sequence of update values and performs the specified changes to the database in a transactional manner. That means that either all the specified changes occur or none of them occurs. Some of the examples below comprise more than one query. Semicolons separate the queries and the system implicitly closes each query containing some update value with a “commit”. Thus, each query transactionally completes prior to the next query where there are multiple queries.

Method: Save

Save serializes an element node as an XML text file. For example, to serialize the value of the variable $node to the file “example.xml”, the following method might be invoked:

xqe:save(“example.xml”, $node)

Method: Load

Load returns an update value that, when committed, inserts a new document from an XML file. Optionally, a URI parameter labeling the loaded document can be provided. For example, the following loads the (serialized XML) file “example.xml” to the database:

xqe:load(“example.xml”)

Method: Document-Insert

Document-insert returns an update value that, when committed, inserts a new document. For example, the following inserts a document:

xqc:document-insert(“example.xml”, <a>aaa</a>)

Method: Document-Delete

Document-delete returns an update value that, when committed, deletes a document from the database. For example, the following deletes a document:

xqe:document-delete(“example.xml”)

Method: Node-Replace

Node-replace returns an update value that, when committed, replaces a node. In a specific implementation, some constraints are applied to keep the data clean, such as rules that:

attribute nodes cannot be replaced by non-attribute nodes,

non-attribute nodes cannot be replaced by attribute nodes,

element nodes cannot have document node children,

document nodes cannot have multiple element node children, and

document nodes cannot have text node children.

An example of a node-replace operation is:

xqe:document-insert(“example.xml”, <a><b>bbb</b></a>);

xqe:node-replace(document(“example.xml”)/a/b, <c>ccc</c>);

document(“example.xml”);

=>

<a><c>ccc</c></a>

In this example, the first query inserts a document with the URI “example.xml” having a root element <a><b>bbb</b></a> into the database. The second query specifies an update which replaces the child “b” of the root element “a” of the document with URI “example.xml” by a new node <c>ccc</c>. The third query returns the document node for the URI “example.xml” with the value shown.

Method: Node-Delete

Node-delete returns an update value that, when committed, deletes a node from the database. In a specific implementation, on-the-fly constructed nodes are not deletable. An example of a node-delete operation is:

xqe:document-insert(“example.xml”, <a><b>bbb</b></a>);

xqe:node-delete(document(“example.xml”)/a/b);

document(“example.xml”)

=>

<a/>

In this example, the first query inserts a document with the URI “example.xml” having a root element <a><b>bbb</b></a> into the database. The second query specifies an update which removes the child “b” of the root element “a” of the document “example.xml”. The third query returns the document node for the URI “example.xml” with the value shown.

Method: Node-Insert-Before

Node-insert-before returns an update value that, when committed, adds an immediately preceding sibling to a node. In a specific implementation, some constraints are applied to keep the data clean, such as rules that:

attribute nodes cannot be preceded by non-attribute nodes,

non-attribute nodes cannot be preceded by attribute nodes,

element nodes cannot have document node children,

document nodes cannot have multiple element node children,

document nodes cannot have text node children, and

on-the-fly constructed nodes cannot be updated.

The arguments preferably specify individual nodes and not node sets. An example of a node-insert-before operation is:

xqe:document-insert(“example.xml”, <a><b>bbb</b></a>);

xqe:node-insert-before(document(“example.xml”)/a/b, <c>ccc</c>);

document(“example.xml”)

=>

<a><c>ccc</c><b>bbb</b></a>

In this example, the first query inserts a document with the URI “example.xml” having a root element <a><b>bbb</b></a> into the database. The second query specifies an update which inserts before the child “b” of the root element “a” of the document “example.xml” a new node <c>ccc</c>. The third query returns the document node for the URI “example.xml” with the value shown.

Method: Node-Insert-After

Node-insert-after returns an update that, when committed, adds an immediately following sibling to a node. In a specific implementation, some constraints are applied to keep the data clean, such as rules that:

attribute nodes cannot be preceded by non-attribute nodes,

non-attribute nodes cannot be preceded by attribute nodes,

element nodes cannot have document node children,

document nodes cannot have multiple element node children,

document nodes cannot have text node children, and

on-the-fly constructed nodes cannot be updated.

The arguments preferably specify individual nodes and not node sets. An example of a node-insert-after operation is:

xqe:document-insert(“example.xml”, <a><b>bbb</b></a>);

xqe:node-insert-after(document(“example.xml”)/a/b, <c>ccc</c>);

document(“example.xml”)

=>

<a><b>bbb</b><c>ccc</c></a>

In this example, the first query inserts a document with the URI “example.xml” having a root element <a><b>bbb</b></a> into the database. The second query specifies an update which inserts after the child “b” of the root element “a” of the document “example.xml” a new node <c>ccc</c>. The third query returns the document node for the URI “example.xml” with the value shown.

Method: Node-Insert-Child

Node-insert-child returns an update item that, when committed, adds a new last child to a node. In a specific implementation, some constraints are applied to keep the data clean, such as rules that:

only element nodes and document nodes can have children,

element nodes cannot have document node children,

document nodes cannot have multiple element node children,

document nodes cannot have text node children, and

on-the-fly constructed nodes cannot be updated.

The arguments preferably specify individual nodes and not node sets. An example of a Node-insert-child operation is:

xqe:document-insert(“example.xml”, <a/>);

xqe:node-insert-child(document(“example.xml”)/a,<b>bbb</b>);

document(“example.xml”)

=>

<a><b>bbb</b></a>

In this example, the first query inserts a document with the URI “example.xml” having a root element <a></a> (with no content) into the database. The second query specifies an update which inserts a new child node <b>bbb</b> below the root element “a” of the document “example.xml”. The third query returns the document node for the URI “example.xml” with the value shown.

As another example:

xqe:document-insert(“example.xml”, <a/>);

xqe:node-insert-child(document(“example.xml”)/a, attribute b {“bbb”});

document(“example.xml”)

=>

<a b=“bbb”/>

In this example, the first query inserts a document with the URI “example.xml” having a root element <a></a> (with no content) into the database. The second query specifies an update which inserts a new attribute child node b=“bbb” below the root element “a” of the document “example.xml”. The third query returns the document node for the URI “example.xml” with the value shown.

Method: Commit

The commit function commits the update items included in the input (that is, actually makes the specified changes to the database), and returns the non-update items included in the input. If the result of every update query is automatically filtered by an implicit call to xqe:commit( ), it need not be called explicitly to commit updates. However, xqe:commit( ) can be called explicitly to allow update queries to catch and handle errors that may occur. For example, a SOAP implementation might catch errors and report them back to the client using the SOAP error reporting mechanism.

After xqe:commit( ) has been called, any deadlock detected by the update query further accessing the database does not result in the update query being retried, but instead results in an error. Deadlock conditions can occur on any database access during the evaluation of an update query. Normally, update queries are automatically retried when a deadlock occurs. After xqe:commit( ) has been called, it would be incorrect to automatically retry the update query, so an error is signaled instead. Because of this, it is good practice for an update query to call commits at most once. For example:

try {

xqe:document-insert(“example.xml”, <a>aaa</a>)

} catch ($errInfo) {

$errInfo

}

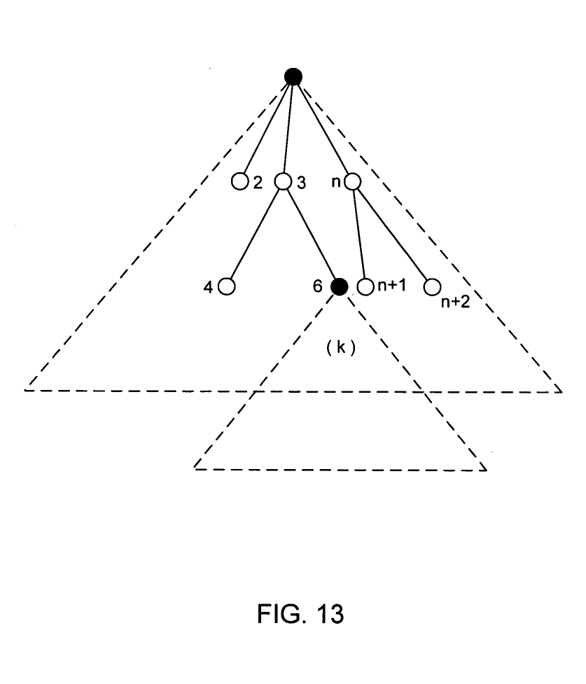

FIG. 13 describes the situation where an update encounters a link node. The dark nodes indicate link nodes. The node numbering describes the “document ordering of the nodes”. The node numbered 1 corresponds to the root node of a subtree which contains the target of some update value. The function copy-and-update traverses this subtree applying update values from the change vector V as it encounters additional update target nodes. The traversal may reach a secondary link node as indicated at node 5. The target of link node 5 is another subtree which may contain additional nodes which need updating.

Each subtree includes in its data attributes a count of the number of nodes within the subtree. This count may be used to determine whether a given node id lies inside the subtree. This determination can be made by calculating a set of numeric inequalities between a given node id (the target of an update value) and the node id of the root of the subtree and the total number of nodes in the subtree.

In addition, when loading documents with a given subtree granularity, the XQE system inserts a certain amount of slack between the last subtree.id used in a child subtree and the next subtree id used in the parent subtree. In this way, the system can insert additional nodes and subtrees into the child subtree without necessarily triggering any renumbering of the node ids in the parent subtree following the child subtree root in document order. In FIG. 13, the child subtree rooted at 5 is indicated to have (k) nodes, and the first following node in the parent subtree has a node id equal to n>5+k.

If an insertion in a linked subtree overflows the preallocated node id slack, then all the following nodes in the parent subtree are copied with incremented node ids.

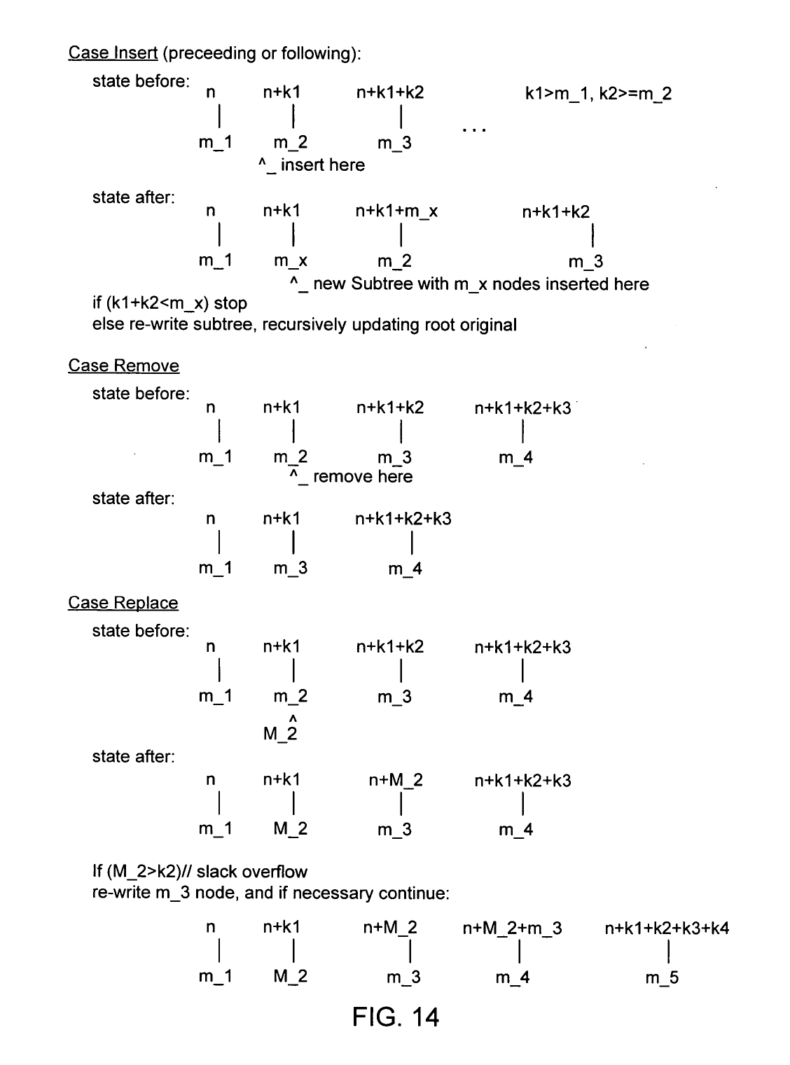

FIG. 14 describes the method for updating the subtree node counts and the subtree id slack. In each portion of FIG. 14, the top row of numeric variables describe the starting Subtree ids for one subtree (with slack) and the bottom row of numeric variables describes the actual Subtree node counts.

After xqe:commit( ) has been called, any deadlock detected by the update query further accessing the database does not result in the update query being retried, but instead results in an error. Deadlock conditions can occur on any database access during the evaluation of an update query. Normally, update queries are automatically retried when a deadlock occurs. After xqe:commit( ) has been called, it would be incorrect to automatically retry the update query, so an error is signaled instead. Because of this, it is good practice for an update query to call commits at most once.

An example of a Commit operation is:

try {

xqe:document-insert(“example.xml”, <a>aaa</a>)

} catch ($errInfo) {

$errInfo

}

Stands and Forests

An XQE subtree-structured XML database system might aggregate subtrees into “stands” that are in turn aggregated in to “forests”. Subtrees are inserted into a forest according to the following process. SubTree insertion occurs either when the data loader detects the end of a document or it completes a traversal of a configured subtree element. The first step in a process of adding a subtree to a forest is finding a suitable stand where the subtree can be added. At any given time, the forest manages a multiplicity of stands, some of which are on-disk stands (read-only objects backed by persistent disk file images that cannot be directly modified) and others are in-memory stands in the process being saved to disk as on-disk stands. In addition, there may be an in-memory stand available for update. If not, then a new in-memory stand is created for the purpose. The following steps then occur:

(1) compute index data

(2) compute Classification data

(3) lock Stand for update

(4) if the database is shutting down, then exit

(5) update the updateable Stand

(5.1) a Journal record is created

(5.2) serialize the Subtree data into the journal record

(5.3) puto Subtree data to InMemoryStand

(5.4) write Journal record

(5.5) set timestamps

(6) catch Full exception and either:

(6.1) flush Stand to OnDiskStand, and return to step (4), or

(6.2) exit if Subtree exceeds the maximum size of one Stand

(7) unlock Stand

Example of Update Algorithm

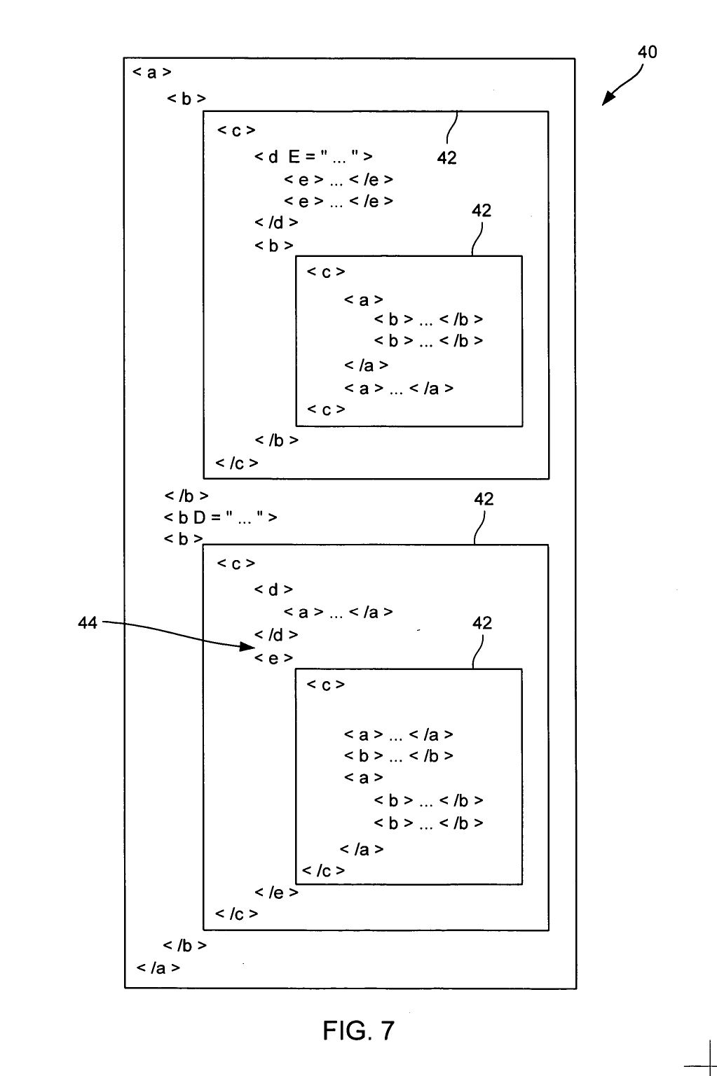

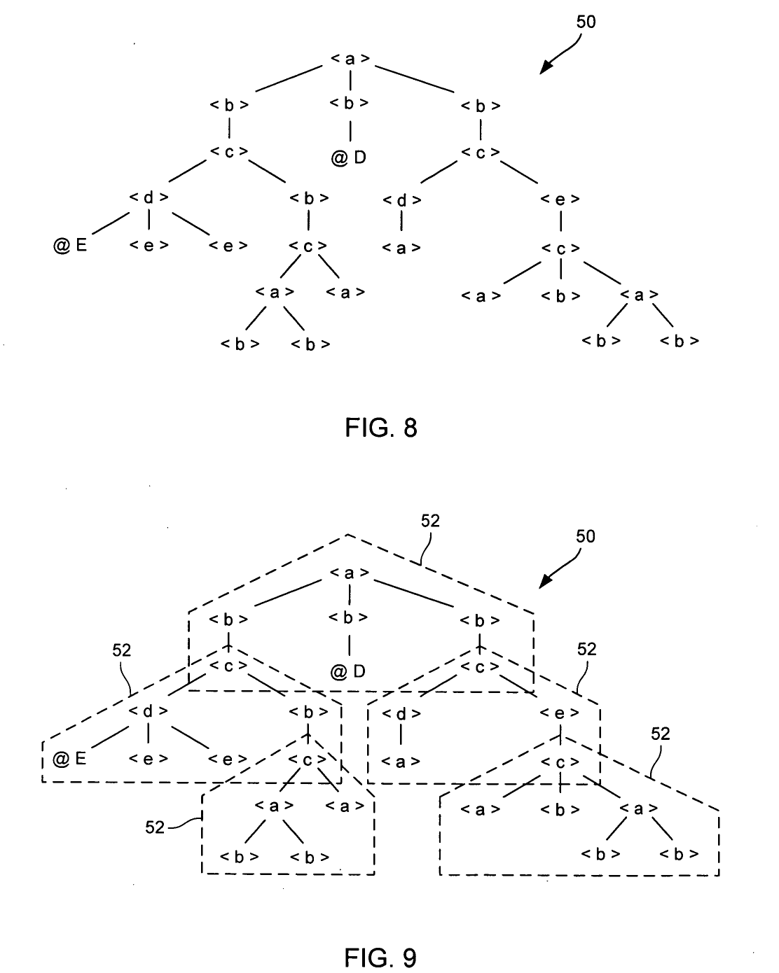

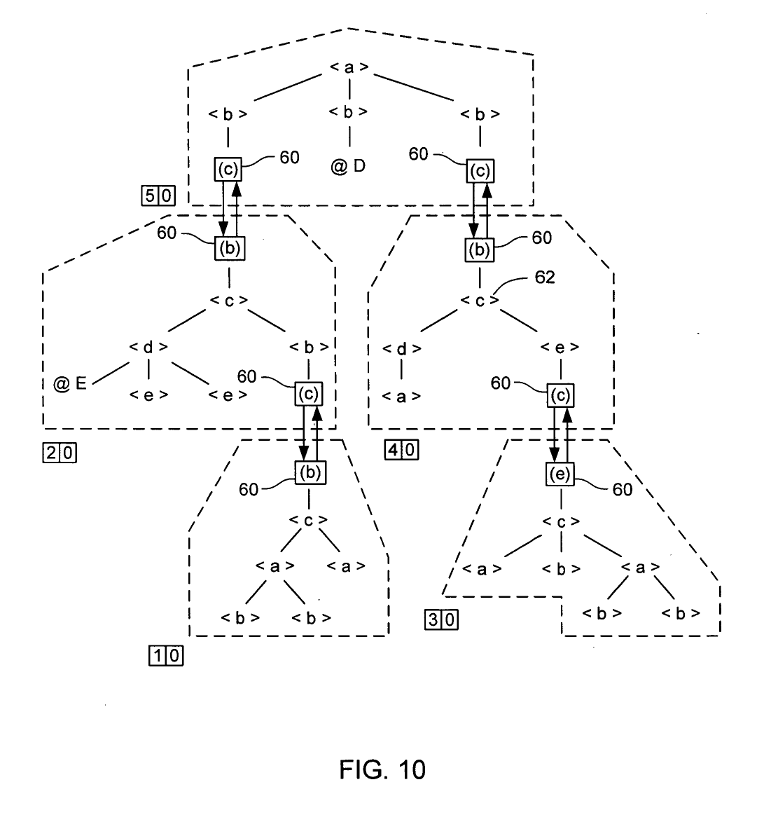

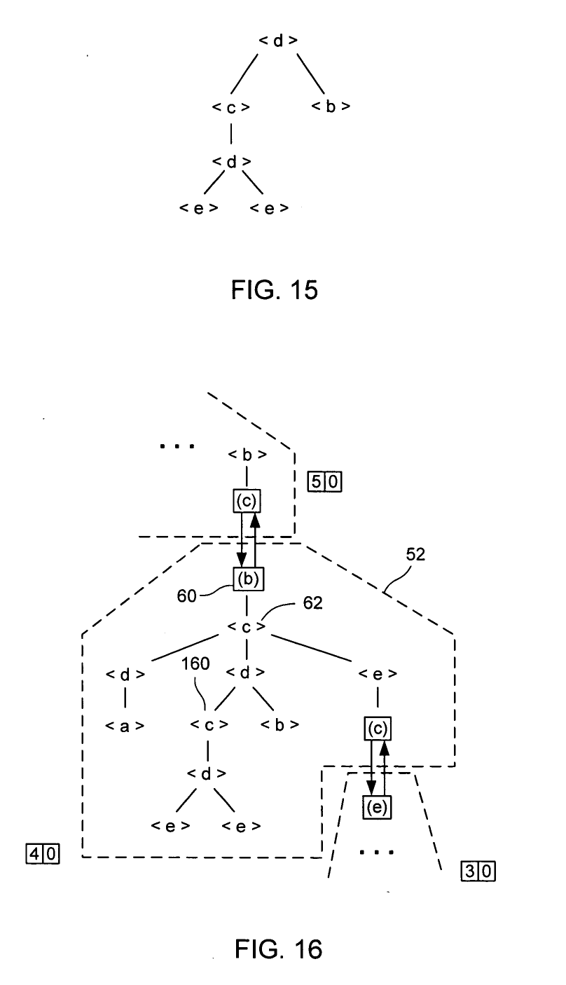

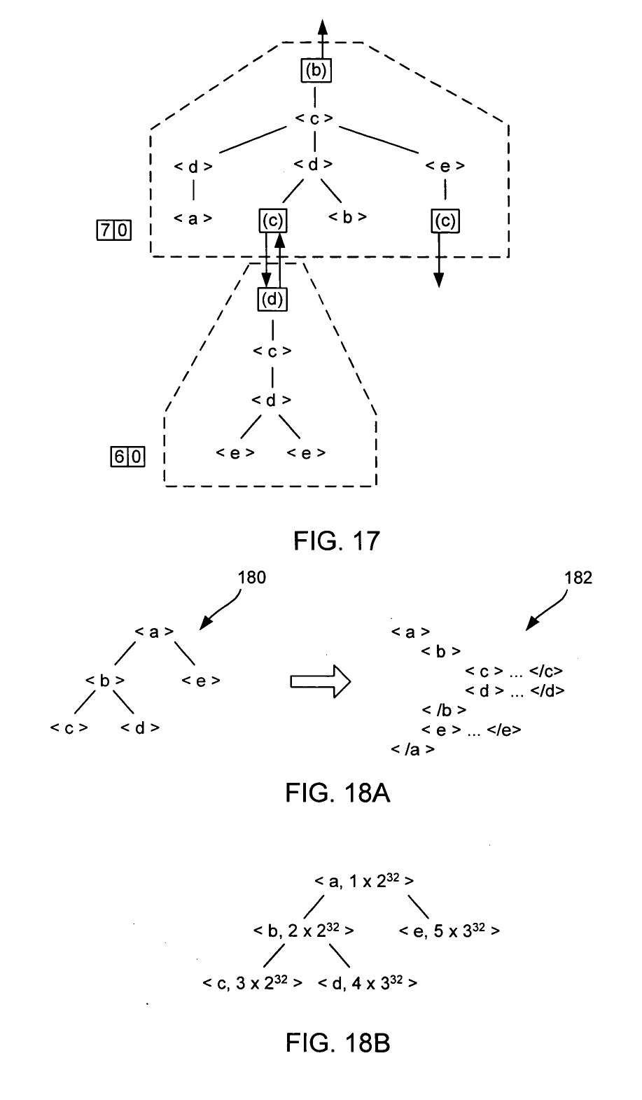

An example of an update algorithm will now be described with reference to FIGS. 15-19. FIG. 15 illustrates a subtree that represents a new document fragment. Suppose an update operation is to insert the new document fragment into the structures shown in FIGS. 7-10, specifically as child node under node 62, which is a “<c>” element, being a sibling between the <d> element and the <e> element. In an XML document, this would correspond to inserting the document fragment into the XML document of FIG. 7 at the point indicated by arrow 44 in FIG. 7. Locally, the new structure would be as illustrated in FIG. 16.

If the decomposition rules were that the decomposition occurs at “<c>” elements, then the subtree with a subtree label of “40” would undergo a refragmentation with node <c> being the root node of the new subtree. Actually, two new subtree fragments would be formed, one representing portions of the added a document fragment (subtree label 60) and another or representing the remaining portions of the subtree labeled 40, which would now be referred to as subtree 70. New subtree fragment identifiers are allocated sequentially in the order that new subtrees are detected and written out to disk. When using facilities described in Lindblad I-A, the two new subtrees are output to a new stand and the old subtree 40 is marked deleted. A background process might merge stands by removing deleted subtrees, concatenating subtree fragment sets, and merging parent-child index lists.

Preferably, nodes in the subtree-structured-XML database are recoverable in “document order”, to facilitate XQuery processing. To do this, each node is assigned a numeric ordinal value, such as a 64-bit number. These ordinals maintain the invariant property that one node comes before another node in the document if and only if the ordinal of the one node is less than the ordinal of the other node. Herein “document order” is defined as the order in which nodes appear when viewed as an actual XML document, from top to bottom. For example, the tree 180 and XML document 182 shown in FIG. 18A represent a document where the document order of nodes is <a>, <b>, <c>, <d>, <e>.

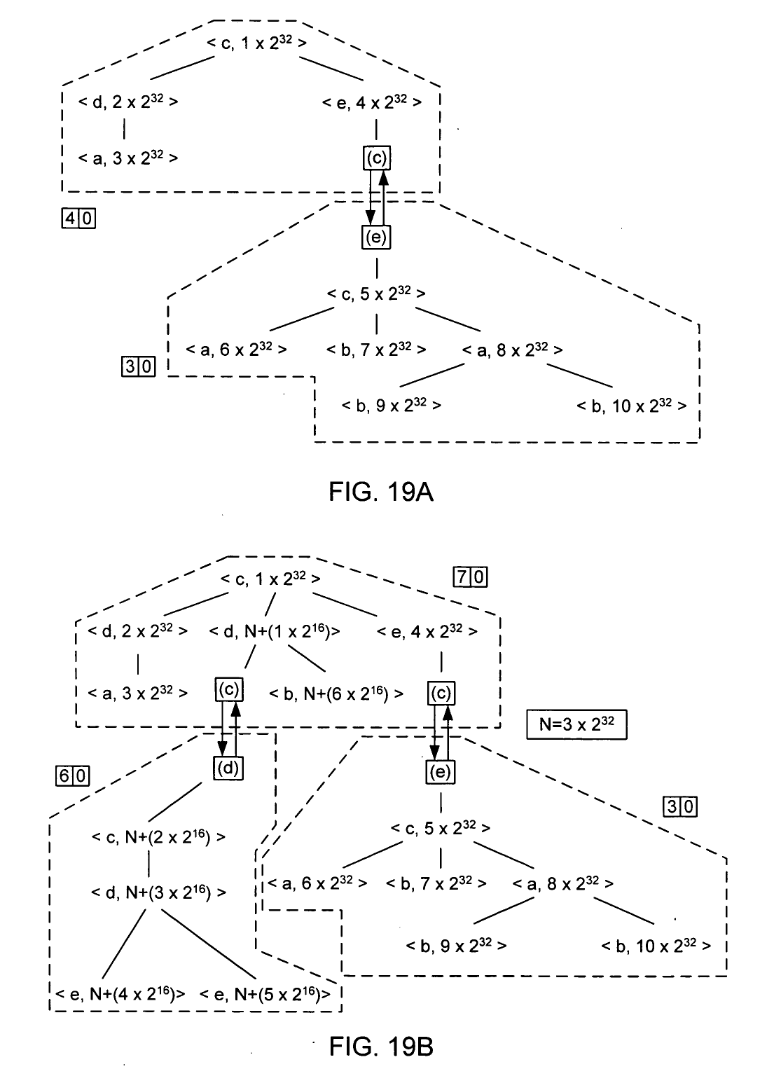

Ordinal values can be assigned a number of different ways. But one example allocates ordinals using higher order bits at the outset and lower order bits as needed for updates. This is illustrated in FIG. 18B for the tree and document shown in FIG. 18A. As illustrated there, the nodes are allocated as a sequential multiples of 2\hat{ }32. The lower order 32 bits can then be used to interpolated ordinal's between existing ordinal sequences in order to maintain the invariant property described above across insertions and deletions of nodes, as illustrated in FIG. 19.

FIG. 19A illustrates portions of the structure used as an example above. Note that each of the nodes is allocated a sequential multiple of 2\hat{ }32. When nodes are added, the new nodes can be assigned ordinals that fall between the ordinals that would be before and after the inserted fragment, with the new nodes having a value that it is a multiple of 2\hat{ }32 plus a multiple of 2\hat{ }16, thereby allowing for later inserts. Of course, at some point after long the sequences of repeated inserts, the system could run out of ordinals and future inserts that require unavailable ordinals would either be prohibited or the ordinals could be all reassigned. One approach to ordinals reassignment is to run through the database with the wave of changes. Another approach is to write out the entire database as one or more XML documents, and then read the one or more XML documents back in, to populate the subtree-structured XML database anew.

Embodiments of the present invention provide an XML database with updatability. When XML data is modified, only a small number of subtrees typically need to be revised. Data compression can also be provided, e.g., by using atoms to represent text data, as well as by applying additional compression techniques when data is written to disk and decompression techniques when data from disk is read into memory to be processed. Queries may be processed efficiently by applying the query to groups of subtrees (i.e., stands) and aggregating the results.

While the invention has been described with respect to specific embodiments, one skilled in the art will recognize that numerous modifications are possible. The data structures described herein can be modified or varied; particular contents and coding schemes described herein are illustrative and not limiting of the invention. Any or all of the data structures described herein (e.g., forests, stands, subtrees, atoms) can be implemented as objects using CORBA or object-oriented programming. Such objects might contain both data structures and methods for interacting with the data. Different object classes (or data structures) may be provided for in-scratch, in-memory, and/or on-disk objects. Examples of methods are described and some objects might have more or fewer objects.

Additional features to support portability across different machines or different file system implementation, random access to large files, concurrent access to a file by multiple processes or threads, various techniques for encoding/decoding of data, and the like can also be implemented. Persons of ordinary skill in the art with access to the teachings of the present invention will recognize various ways of implementing such options.

Various features of the present invention may be implemented in software running on general-purpose processors, dedicated special-purpose hardware components, and/or any combination thereof. Computer programs incorporating features of the present invention may be encoded on various computer readable media for storage and/or transmission; suitable media include suitable media include magnetic disk or tape, optical storage media such as compact disk (CD) or DVD (digital versatile disk), flash memory, and carrier signals adapted for transmission via wired, optical, and/or wireless networks including the Internet. Computer readable media encoded with the program code may be packaged with a device or provided separately from other devices (e.g., via Internet download).

Thus, although the invention has been described with respect to specific embodiments, it will be appreciated that the invention is intended to cover all modifications and equivalents within the scope of the following claims.

APPENDIX A
Subroutines For Node Updating

for each node update u(n) in change vector V:

find the subtree S containing the node n;
copy-and-update(V, S, u.root( ));

// recursive subtree traversal
copy-and-update(ChangeVector V, Subtree S, Node node):

if (exists node-replace for node) then replace node; return;
for (each node-insert-before(node, n))

insert new node n into output subtree;
remove node-insert-before update value from change vector V;
break;

switch (nodeKind(node)):

case ElemNodeKind:

for (attr in node attributes) copy-and-update(V, S, attr);
for (child in node children) copy-and-update(V, S, child);
for (each node-insert-child(node))

insert new child to node in output subtree;
remove node-insert-child update value from change vector V;

break;

case DocNodeKind:

for (child in node.children( )) copy-and-update(V, S, child);
break;

case LinkNodeKind:

if (link to parent = first node in tree) then

copy node to output tree;

else

check for updates in link target subtree;
if (no updates in link target subtree) then

copy link node to output subtree;

else

copy-and-update(V, link target subtree, link target subtree root);

for (each node-insert-after(link target, n))

insert n after parent in output subtree;
remove node-insert-after update value from change vector V;

break;

case TextNodeKind:
case PINodeKind:
case CommentNodeKind:

copy node to output subtree;
break;

end-switch
if (parent(node) is not a link node) then

for (each node-insert-after(node, n))

insert n after node in output subtree;
remove node-insert-after update value from change vector V;

end-copy-and-update

What is claimed is:

1. In an XML handling system, wherein XML documents are stored in structured forms, a method of updating an XML document without requiring global changes to the XML document, the method comprising:
organizing a representation of the XML document as a collection of subtrees, wherein a subtree represents a connected set of one or more nodes and wherein a node represents an XML element, content, attribute or value;
identifying an affected set comprising subtrees that would be affected by an update instruction;
creating a replacement set of one or more subtrees that would substitute for the subtrees in the affected set;
adding the replacement set to the representation; and
marking each of the subtrees in the affected set as being no longer part of the representation.

2. The method of claim 1, wherein marking a subtree as being no longer part of the representation comprises setting a delete flag for the subtree.

3. The method of claim 1, further comprising assigning an ordinal value to each node such that if and only if a first node comes before a second node in the XML document, the ordinal value assigned to the first node is less than the ordinal value assigned to the second node.

4. The method of claim 3, wherein the ordinal values are assigned as multiples of a number greater than one such that unassigned ordinal values exist between each initially assigned ordinal value, thereby providing for ordinal values that could be assigned to subsequently inserted nodes.

5. The method of claim 1, wherein the update instruction is one of Save, Load, Document-insert, Document-delete, Node-replace, Node-delete, Node-insert-before, Node-insert-after, Node-insert-child and Commit.
